(19) United States
(12) Patent Application Publication
(10) Pub. No.: US 2011/0253686 A1
(43) Pub. Date: Oct. 20, 2011

(54) Laser Processing Machines and Methods

(75) Inventors: Urs Keel, Bad Ragaz (CH); Alois Fischli, Mels (CH); Erich Siegrist, Tamins (CH); Urs Fluetsch, Klosters Dorf (CH)

(73) Assignee: TRUMPF WERKZEUGMASCHINEN GMBH + CO. KG, Ditzingen (DE)

(21) Appl. No.: 13/086,813

(22) Filed: Apr. 14, 2011

(30) Foreign Application Priority Data
Apr. 19, 2010 (DE) 102010027927.7

(51) Int. Cl. B23K 26/00; B23P 23/00

(52) U.S. Cl. 219/121.67; 29/401.1

(57) ABSTRACT

The invention relates to a laser processing machine for selectively processing plate-like or pipe-like workpieces, including: a displacement device to which a workpiece table for supporting a plate-like workpiece can be secured in order to move the workpiece table into and out of a processing range of the laser processing machine and a handling device for handling a pipe-like workpiece when the pipe-like workpiece is processed in the processing range, the handling device having at least one support device for supporting the pipe-like workpiece during the processing operation. The support device can be moved in a controlled manner in the longitudinal direction (X) of the pipe-like workpiece over at least 20% of the processing range. The invention also relates to methods for retrofitting laser processing machines from processing plate-like workpieces to processing pipe-like workpieces.

### CROSS REFERENCE TO RELATED APPLICATION

This application claims priority under 35 U.S.C. §119(a) to German Patent Application No. 10 2010 027 927.7, filed on Apr. 19, 2010, the entire contents of which are hereby incorporated by reference.

### TECHNICAL FIELD

The present invention relates to laser processing machines and to methods of retrofitting laser processing machines for processing plate-like workpieces to allow for processing of pipe-like workpieces.

### BACKGROUND

Laser cutting machines are commonly used to cut parts from planar metal sheet workpieces. When cutting two-dimensional parts, movement along the plane is generally sufficient to reach all locations on the metal sheet workpiece. So-called flat bed laser cutting machines are most commonly used for this purpose. In flat bed laser cutting machines, the workpiece is typically supported during processing by a processing table and the laser processing head is moved over the workpiece in a plane (i.e., an X-Y plane) within a predefined processing range that is typically defined by the travel distance of the laser processing cutting head.

In order to cut a contour on a workpiece with a laser processing machine, the laser beam and the workpiece must move relative to each other. During processing, either the laser cutting head or the workpiece can be moved to achieve the relative motion. Such relative motion can be carried out in one or more axes to process either a plate-like or a three-dimensional workpiece.

The construction of a laser processing machine can determine the type of workpiece which can be cut using the machine. In general, the processed workpiece material may be planar metal sheets, pipes, and profile-members or preformed, three-dimensional workpieces. Planar metal sheets, pipes, and profile-members are available as semi-finished products in a large number of types and thicknesses of material and are supplied with standard dimensions that can be processed in laser processing machines.

Two dimensional, flat bed laser processing machines can be modified to allow the machine to perform three dimensional workpiece laser cutting, such as cutting pipes or profiled workpieces. For such a modification, the workpiece support that is commonly used with two-dimensional flat bed laser processing machines to support planar metal sheets (commonly referred to as “pallets”, generally “slats”) is removed from the processing range of the laser processing machine. With the planar workpiece support removed, an additional handling device is introduced into the processing range. The additional handling device has a rotatable clamping chuck to grip a workpiece, which forms an axis of rotation that allows processing of the rotating workpiece. Such a laser processing machine has been described in EP0548006 A2, which shows a tailstock that can be secured to a workpiece end that is opposite the clamping chuck being used to guide the workpiece.

A similar device is offered by the Applicant of EP0548006 A2, under the name “RotoLas” as an option for flat bed laser machines. In addition to the rotary chuck which provides an axis of rotation and means for rotating a pipe workpiece, one or more supports are mounted in the processing range that ensure the pipe workpiece is securely supported in the processing region. The supports are movable in the longitudinal direction of the pipe, and can be translated by a pneumatic cylinder to drive the supports. However, the supports are typically only capable of moving relatively small distances (e.g., approximately 220 mm over a processing range of approximately 3000 mm) in order to allow for processing of the workpiece in dead ranges, which may occur when, for example, rectangular pipes to be processed are positioned on plate-like supports.

### SUMMARY

In certain aspects of the invention, a flat bed laser processing machine has a support device that can be moved in a controlled manner in a longitudinal direction of a pipe-like workpiece over at least 20% of the processing range, and in some cases, over at least half of the processing range.

In some embodiments, a laser processing machine of this type can provide increased flexibility with regard to the positioning of workpiece supports. Additionally, systems and methods described herein allow flat bed laser cutting systems to be retrofitted to process pipe/profile-member workpieces with less complexity than the methods described in EP0548006 A2.

According to certain aspects of the invention, a pipe workpiece support device with a drive device is provided, which allows the support device to be moved in an automatic and controlled manner in the longitudinal direction of the pipe throughout the processing range. In particular, the displacement of the support device is intended to be at least a length which corresponds to at least 20% of the processing range, and typically up to approximately 80% to 90% of the total length of the processing range. The processing range can be defined by the maximum travel distance of a laser processing head along the y-direction, along the x-direction, and/or along a longitudinal axis of a pipe-like workpiece. The processing range can depend on the size of the workpieces to be processed and can be, for example, approximately 1000 mm×2000 mm in metal sheets in the form of so-called small plates, approximately 1250 mm×2500 mm in the case of so-called medium-sized plates, and approximately 1500 mm×3000 mm in the case of so-called large plates. The length over which the support device can be moved in the longitudinal direction in a controlled manner generally depends on the number of support devices which are arranged in the longitudinal direction of the pipe-like workpiece. It has been found to be advantageous for the support device to be movable in a controlled manner at least over a length of approximately 50% of the processing range.

In particular, the movement of the support device and the movement of the laser processing head can be coordinated, such that the pipe-like workpiece can always be supported by the support device at a location which is optimized for the processing operation. In addition to simple pipes or tubing, the term pipe-like workpieces is also intended to refer to profiled workpieces that can be clamped in a rotatable clamping chuck of the handling device and can be rotated about an axis of rotation formed by the chuck for processing.

In some embodiments, the support device is secured to a displacement device used to displace the workpiece table or a displacement device used to displace a laser processing head. The displacement device for the workpiece table provides displacement of the workpiece table in a longitudinal direction of the processing range, which is also the longitudinal direction of the pipe-like workpiece. The workpiece table displacement device drive mechanism for displacing the workpiece table, which is typically not otherwise used for processing pipes, can therefore be advantageously used to move the support device in the longitudinal direction of the workpiece.

It is also possible to use the displacement device that moves the laser processing head (in a longitudinal direction) for controlled movement of the support device in the longitudinal direction of the pipe-like workpiece. In this type of workpiece support, the support device can be secured to a transverse carrier to which a laser processing head is also fitted. The transverse carrier can be displaced in the longitudinal direction of the pipe, so as to make the support device displaceable in the longitudinal direction. When the support device is connected to the laser processing head displacement device in this manner, there is a mechanical coupling between the movement of the laser processing head and the movement of the support device in the longitudinal direction of the pipe (e.g., the laser processing head and the support device are arranged with constant spacing from each other when the laser processing head is moved).

Conversely, when the support device movement is controlled by the drive for the workpiece table displacement device, instead of using a direct mechanical coupling to the laser head processing movement, the relative motion between the support device and the laser processing head can be coordinated in a more flexible way, as they can be moved independent of each other. It is also possible, as an alternative to the above-described embodiments, to provide additional drive mechanisms on the laser processing machine for moving the support device.

In some embodiments, the workpiece table displacement device and/or the laser processing head displacement device are operated with a chain drive. A chain drive has been found to be advantageous, particularly for displacing the workpiece table, because it can allow for translating a first workpiece table from a loading and unloading position into the processing range to be processed, while simultaneously translating another workpiece table away from the processing range towards the loading and unloading position. By using one chain, the dual motion of translating one workpiece into the processing range and translating another workpiece out of the processing range can be achieved in one operation.

In some embodiments, the chain drive has a chain with at least one carrier to which the support device can be secured. The carrier can engage in a carrier receiving member on the support device in order to secure the support device to the displacement device. It is possible to use the same carriers used to secure the workpiece table when processing sheet workpieces as carriers for the support devices, or it is also possible to provide additional carriers on the chain to be used specifically for the support device.

In some embodiments, the support device has a coupling device, which engages with the chain, to secure the support device to the chain of the chain drive. The coupling device engages directly with the chain links of the chain and can consequently be secured to the chain at any position along the chain. In order to ensure particularly simple coupling between the chain and the coupling device, the coupling device can have a catch which allows a hook that engages between the chain links to be raised or lowered in order to engage and/or disengage the coupling device with the chain.

In some embodiments, the laser processing machine has a guide device for guiding the support device during displacement within the processing range. The guide device can be in the form of a guide rail which extends in the longitudinal direction of the pipe, and to which the support device can be fitted, for example, via a guide carriage. The support device can thereby be moved with precision in the longitudinal direction of the pipe.

In some embodiments, the support device forms a support to support pipe-like workpieces during processing. Different types of supports have traditionally been used for differently profiled pipe-like workpieces. Therefore, it is advantageous for the support device to be divided into at least two pieces, a base carrier and a workpiece carrier. The base carrier can be connected to the displacement device to provide displacement capabilities. The workpiece carrier, which can be connected to the base carrier, can be adapted to support the various individual shapes and profiles of pipe-like workpieces to be processed.

In some embodiments, the support device forms a feed through chuck for the pipe-like workpiece. The feed through chuck has multiple clamping jaws (typically four or more) which are provided with rollers to permit smooth rotation of the pipe-like workpiece. Unlike the use of devices that only support the height of the workpiece, the feed through chuck is also capable of rotating the workpiece so that no individual adaptation to the cross-sectional geometry of the pipe-like workpiece has to be performed. Consequently, it is possible to dispense with spacer pieces as required in the other supports to allow for receiving circular pipes having different diameters. Similarly, it is possible to provide base plates and/or fixing plates which correspond to pipe dimensions of rectangular pipes such that the base plates and/or fixing plate can be fixed around the pipe-like workpiece. Such base plates and fixing plates allow for rotation of non-cylindrical shaped workpieces.

The laser processing system typically has a rotatable clamping chuck for clamping the pipe-like workpiece during processing. The clamping chuck forms an axis of rotation for processing the pipe-like workpiece, about which the workpiece can be rotated during processing. A pipe-like workpiece can be introduced from a supply system by the rotatable clamping chuck into the processing range. The clamping chuck can be fitted to the laser processing system permanently. However, it is also possible for the clamping chuck to be used in a more temporary manner, only to be introduced into the laser processing machine when pipe-like workpieces are to be processed.

In some embodiments, the laser processing machine has a laser processing head which is movable within the processing range. Typically, the laser processing head can be displaced in the processing range both in a longitudinal direction (along the X axis) and in a transverse direction (along the Y axis), this can be referred to as a floating optical unit. When using a floating optical unit, the processing range is defined by all the locations which the laser processing head can reach in the XY plane for laser processing. For this type of laser processing displacement, the laser processing head can be provided on a bridge device which can be displaced in both the longitudinal direction (X direction) and can be displaced along that bridge in the transverse direction (Y direction).

In some embodiments, the laser processing machine includes a control device for coordinating the movement of the laser processing head and the movement of the support device for a pipe-like workpiece, in the longitudinal direction. Such coordinated movement is advantageous if the support device and the laser processing head can be controlled individually by two separately controllable drives. This may be the case, for example when the support device is secured to the displacement device for the workpiece table. When implementing independent, coordinated movement, the optimum position for supporting the workpiece can typically be achieved. This optimum position is typically as near the laser processing head as practical in order to achieve the greatest accuracy possible. The optimum position is near the laser processing head because pipe-like workpieces are typically not completely straight and/or they may have slightly variable diameters in the longitudinal direction of the pipe, so having the support near the laser processing head can increase the accuracy of the laser processing. However, the optimum position must be far enough from the cutting head so that collisions between the support device and the cutting contour can be avoided.

Another aspect of the invention relates to a method of retrofitting a laser processing machine from processing plate-like workpieces to processing pipe-like workpieces. The retrofitting method includes securing a support device for supporting a pipe-like workpiece to a displacement device of the laser processing machine for the controlled movement of the support device in a longitudinal direction of the pipe-like workpiece over at least 20%, (e.g., over at least half of the processing range). The flexibility to support pipe-like workpieces during processing can be increased by the controlled movement of the support device.

In some embodiments, the support device can be secured to a displacement device used to displace the workpiece table or a displacement device used to displace a laser processing head. In such embodiments, the drive of the displacement device can therefore be used to move or displace the support device.

Other aspects, features, and advantages of the invention will be appreciated from the description and the drawings.

### DESCRIPTION OF DRAWINGS

FIG. 1 is a perspective view of a laser processing machine for processing plate-like and/or pipe-like workpieces;

FIG. 2 is a perspective view of a support for supporting a pipe-like workpiece which is secured to a chain of a displacement device for moving a workpiece table;

FIG. 3a and FIG. 3b are perspective views of the chain of FIG. 2, with carriers disposed thereon;

FIG. 4 is a perspective view of the chain shown FIG. 3b, in which a carrier receiving member is engaged with a carrier of the chain, in order to move the workpiece table into a processing range; and

FIG. 5 is a schematic illustration of a pipe-like workpiece which is supported by a feed through chuck during the laser processing.

### DETAILED DESCRIPTION

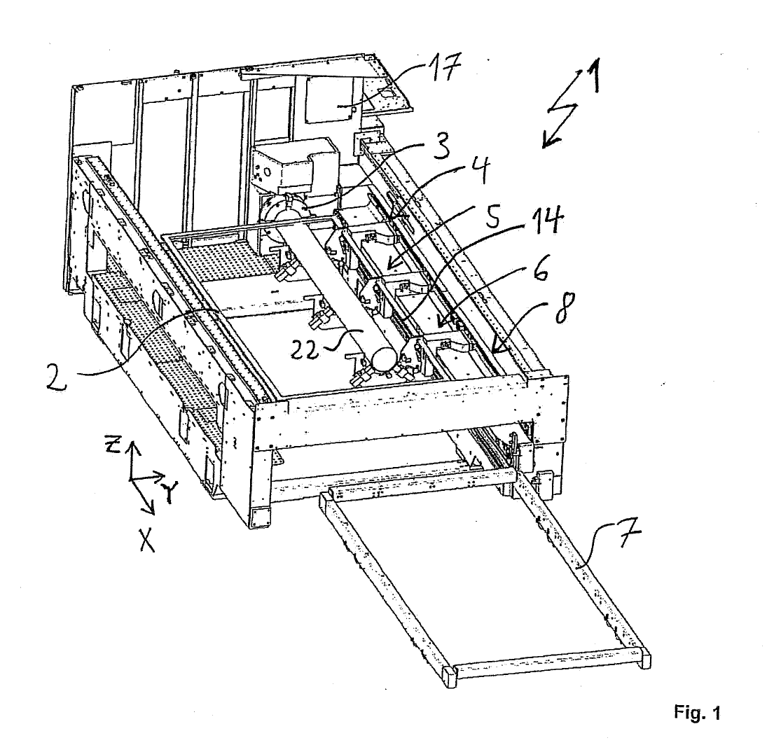

FIG. 1 shows a laser processing machine 1 in the form of a flat bed laser machine for selectively processing plate-like and/or pipe-like workpieces. As shown in FIG. 1, the laser processing machine 1 is provided to process pipe-like workpieces. To allow processing pipe-like workpieces, a rotatable clamping chuck 3 is provided through which a pipe-like workpiece 22 can be introduced into a rectangular processing range 2. The rotatable clamping chuck 3 is fitted to the edge of the rectangular processing range 2 of the laser processing machine 1. The rotatable clamping chuck 3 defines an axis of rotation, about which the pipe-like workpiece 22 can be rotated during processing. In a longitudinal direction (shown as the X direction), three supports 4, 5, 6 are arranged along the processing range 2 which serve to support the pipe-like workpiece 22 during processing. Alternatively, more or fewer supports could be used to support the workpiece. For example, as few as one support, or as many as 10 supports could be used. The supports 4, 5, 6 are positioned in such a manner that the center axis of the pipe-like workpiece 22 is orientated in a longitudinal or X direction, so that the center axis is approximately parallel to the side wall of the laser processing machine 1. The exemplary processing range 2 shown in FIG. 1 has a length (e.g., in the X direction) of 3000 mm and a width (e.g., in the Y direction) of 1500 mm, and thus serves to process large-format metal sheets.

Also in FIG. 1, a frame of a workpiece table 7 is shown in a loading and unloading position which is outside the processing range 2. The loading and unloading position is used so that plate-like workpieces or workpiece parts can be loaded and unloaded for processing. The workpiece table 7 can be moved using of a chain drive 8 which acts as a displacement device in the longitudinal direction (X direction) from the loading and unloading position to a processing position in the processing range 2, as described below in greater detail, in order to process plate-like workpieces arranged thereon.

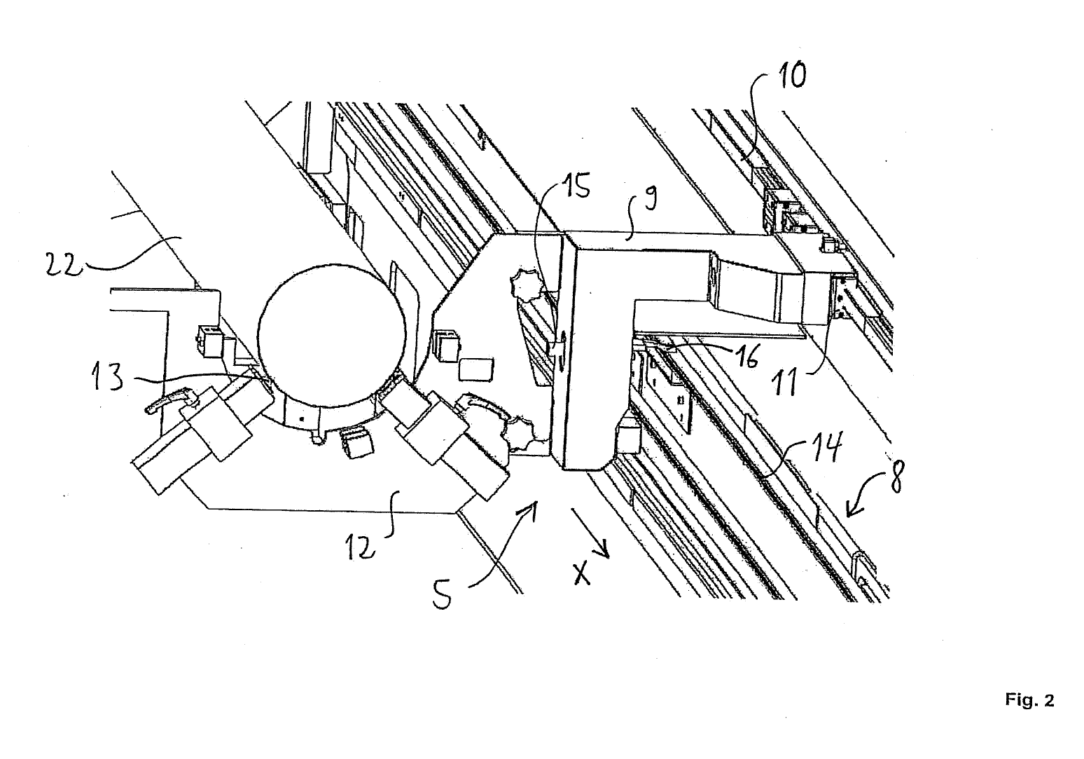

In some embodiments, the chain drive 8 is not necessary for processing pipe-like workpieces. However, the chain drive 8 can be used during processing of pipe-like workpieces in order to displace the supports 4, 5, 6. This operation is described in greater detail below with reference to the central support 5 which is illustrated in detail in FIG. 2.

As shown in FIG. 2, the central support 5 includes a base carrier 9 to provide displacement capabilities and a workpiece carrier 12 to support the workpiece. The base carrier 9 is secured (e.g., clamped) to a carriage 11 which is movably supported on a guide rail 10 in order to guide the support 5 along the guide rail 10 in the X direction. The base carrier 9 is further secured to a chain 14 of the chain drive 8, by which the base carrier 9 is initially moved in the X direction to a desired position.

The workpiece carrier 12 is clamped, locked, or otherwise fastened to the base carrier 9, and has one or more fitted rollers 13, on which the pipe-like workpiece 22 is supported during processing.

Further shown in FIG. 2, the central support 5 has a catch 15 which serves to raise and lower a hook 16 that engages the chain 14 of the chain drive 8 at any location along the chain 14. With the hook 16 engaged in the chain 14, the support 5 is secured to the chain 14 and can be moved in the longitudinal direction (X direction) in a controlled manner by the chain drive 8.

Referring back to FIG. 1, since the chain drive 8, used for moving a workpiece, is operated independently of a drive for moving a laser processing head (not shown), the central support 5 can be moved independently of the laser processing head. A control device 17 controls operation of the chain drive 8 and a device used to position the laser processing head. Therefore, both movements can be coordinated so that the support 5 is always moved in the X direction at a position which is optimum for processing or supporting a specific workpiece type. As discussed above, this optimum position is as near the laser processing head as practical in order to achieve a high level of accuracy. However, the optimum position is also far enough from the cutting head so that collisions between the support 5 and the cutting contour can be avoided.

The displacement range of the support 5 is typically greater than approximately 50% of the length of the processing range 2 in a longitudinal direction (X direction) and is limited by the locations of the other supports 4, 6 which are fixed in position. If, as shown in FIG. 1, all the supports 4, 5, 6 are secured to the chain 14 of the chain drive 8 in the manner discussed above with regards to the central support 5 and are therefore displaced together, the maximum length of the displacement range of the supports 4, 5, 6 depends on the spacing of the supports 4, 5, 6. However, the displacement range of the supports 4, 5, 6 is typically at least 20% of the total length of the processing range 2 in order to have proper flexibility in supporting the pipe-like workpiece 22.

While certain embodiments have been described, other embodiments are possible.

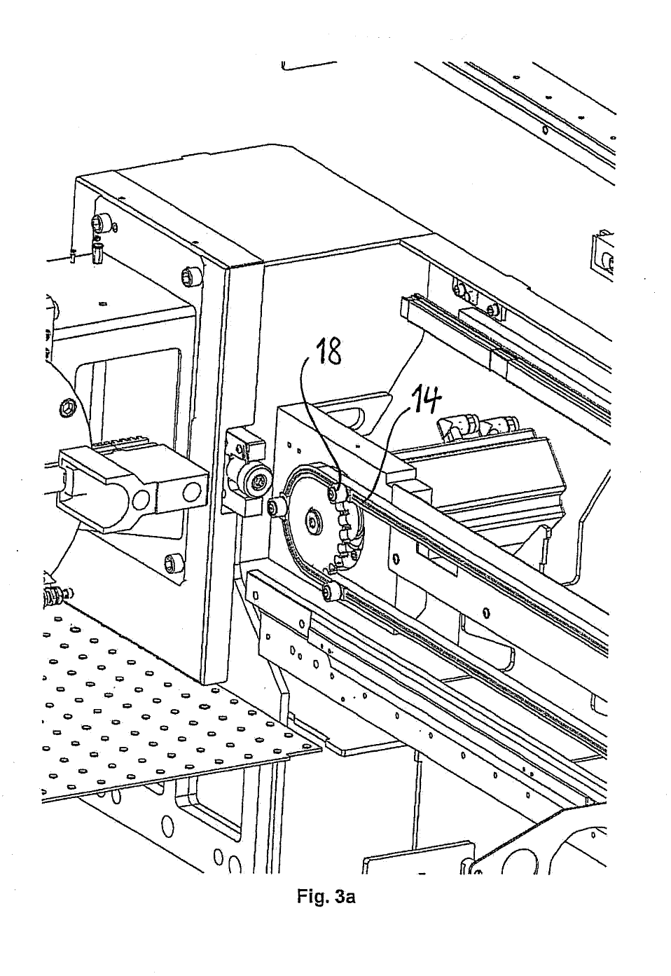

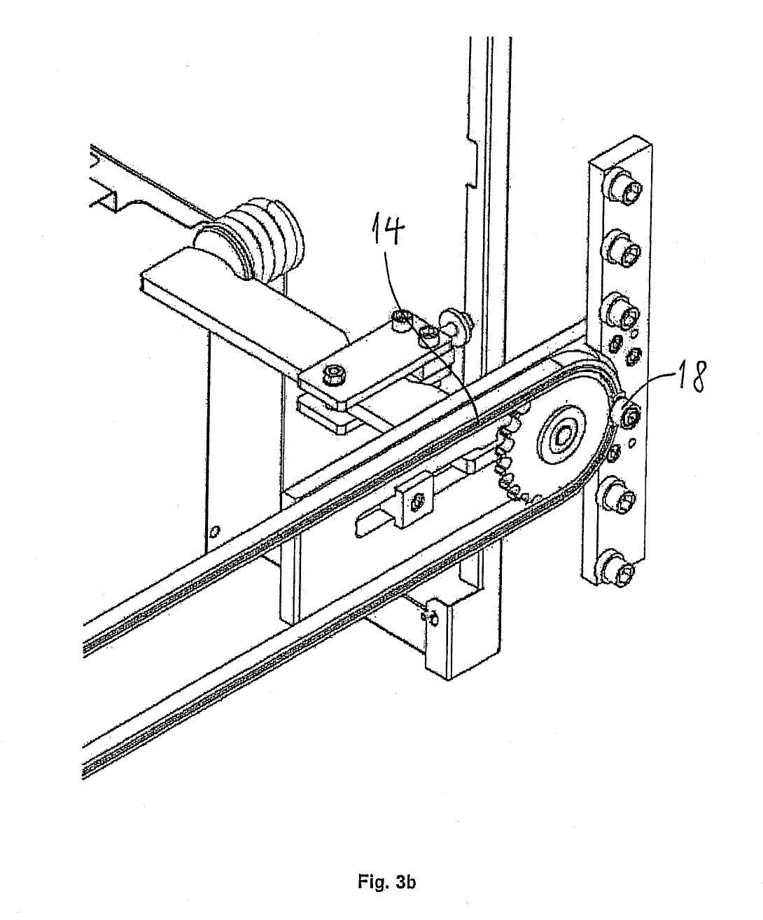

Although the coupling mechanism of the support 5 to the chain 14 has been described as catch 15 and hook 16 mechanism as shown in FIG. 2, other types of coupling mechanisms can be used. For example, as illustrated in FIG. 3a and FIG. 3b, the support 5 can be secured to carriers 18 which are fitted to the chain 14 and serve to carry the workpiece table 7. In such embodiments, the support 5 may have carrier receiving members (not shown), in which one or more of the carriers 18 of the chain 14 can engage to secure the support 5 to the chain 14.

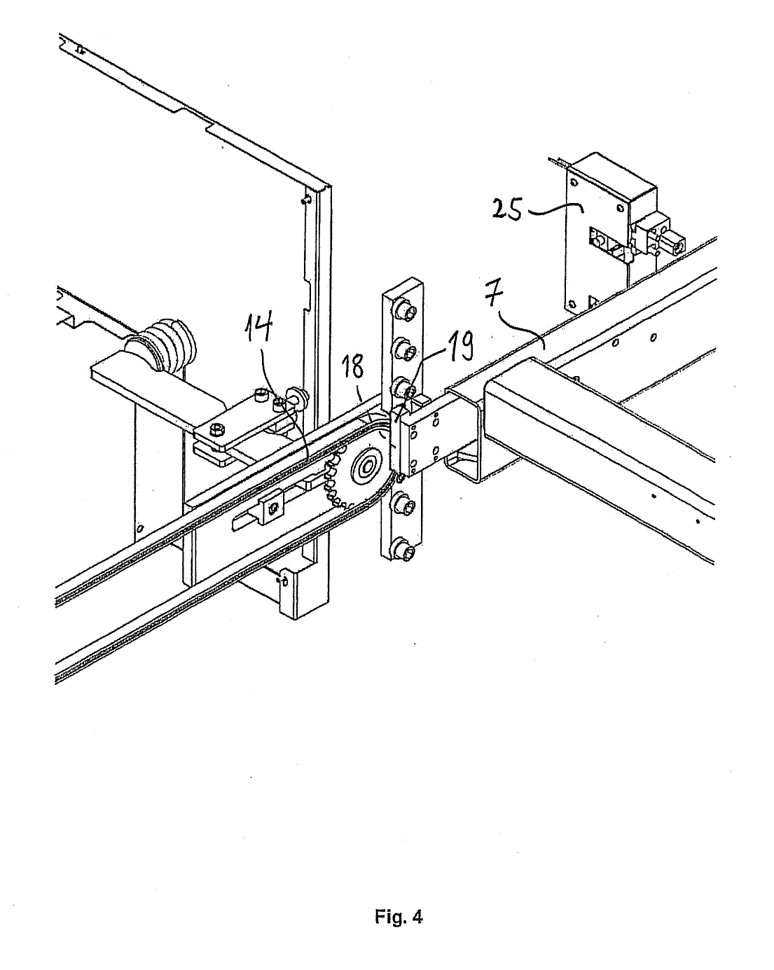

In FIG. 4, such carrier receiving members are shown in the form of carrier bars 19 of the workpiece table 7. As discussed above, the chain drive 8 is used to move the workpiece table 7 from the loading and unloading position to the processing range 2, and vice versa (as illustrated in FIG. 1). In the loading and unloading position, the workpiece table 7 is secured to a fixing unit 25 in order to prevent undesirable displacement out of the loading and unloading position. In order to move the workpiece table 7 into the processing range 2, the table 7 is released by the fixing unit 25 and first raised to a carrying position, in which the carrier 18 of the chain 14 engages with the carrier receiving member 19 on the workpiece table 7.

When the chain 14 is rotated, the workpiece table 7 is drawn into or out of the processing range 2, as discussed above. Once the desired position is reached, the workpiece table 7 can be raised or lowered. In order to change the first workpiece table 7 arranged at the loading and unloading position for a second workpiece table (not illustrated), one of the carriers 18 of the chain 14 engages with a carrier receiving member of the first workpiece table. While the second workpiece table (not shown) is drawn out of the processing range 2, the first workpiece table 7 is drawn into the operating position within the processing range 2. This is possible because the upper half and lower half of the chain 14 move in opposite directions.

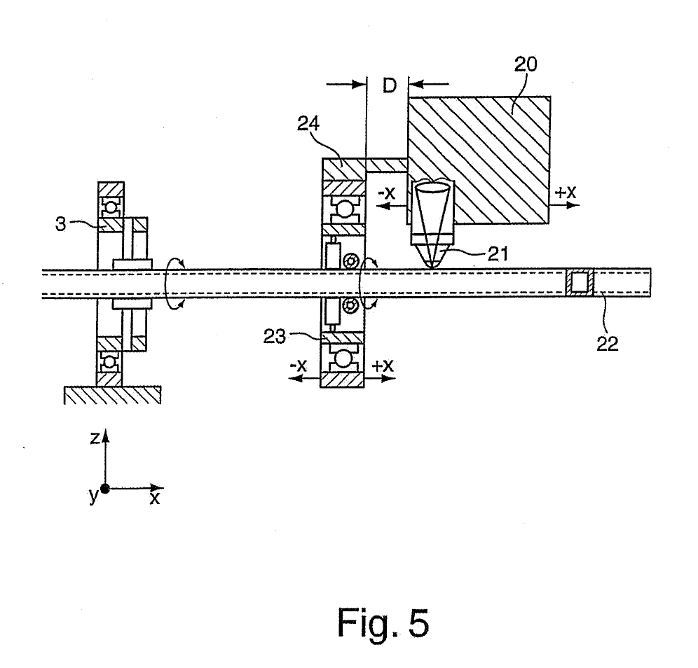

Although the support 5 has been described as being secured to the chain 14 of the chain drive 8 to provide displacement capabilities, other displacement mechanisms are possible. For example, as shown in FIG. 5, it is possible to secure the support device to a transverse carrier 20 (bridge) which can be displaced in the X direction, on which a laser processing head 21 is disposed for displacement in a transverse direction (Y direction). In such embodiments, a feed-through chuck 23 that has a plurality of clamping jaws having rollers in order to follow the rotation of the workpiece 22 and serves to support the pipe-like workpiece 22 is secured to the transverse carrier 20 by a base carrier 24.

The spacing D, which is the distance between the feed-through chuck 23 and the transverse carrier 20 is constant and does not vary during processing of the pipe-like workpiece 22 because the feed-through chuck 23 that supports the workpiece 22 is mechanically coupled to the transverse carrier 20 by the base carrier 24. By using base carriers 24 of different lengths, however, it is also possible to adapt the spacing D to a particular workpiece type, before the processing operation begins. Alternatively, the base carrier 24 may be constructed in a telescoping manner to allow the spacing D to be adjusted during the processing operation.

In other embodiments, a support 5 can alternatively be connected directly to the transverse carrier 20 in place of the base carrier 24.

In other embodiments, the feed-through chuck 23 can alternatively be secured to the chain 14 of the chain drive 8. In the above mentioned embodiments, a displaceable pipe support providing a coupled displacement can be provided to allow optimization of cutting and processing pipes in laser processing machines for selectively processing plate-like or pipe-like workpieces.

A number of embodiments of the invention have been described. Nevertheless, it will be understood that various modifications may be made without departing from the spirit and scope of the invention. Accordingly, other embodiments are within the scope of the following claims.

What is claimed is:

1. A laser processing machine for selectively processing plate-like or pipe-like workpieces, comprising:
a displacement device to which a workpiece table for supporting a plate-like workpiece can be secured to move the workpiece table into and out of a processing range of the laser processing machine; and
a handling device for handling a pipe-like workpiece when the pipe-like workpiece is processed in the processing range, the handling device comprising at least one support device for supporting the pipe-like workpiece during a processing operation,
wherein the support device is configured to move in a controlled manner in the longitudinal direction of the pipe-like workpiece over at least 20% of the processing range.

2. The laser processing machine according to claim 1, wherein the support device can be secured to the displacement device for the workpiece table.

3. The laser processing machine according to claim 2, wherein the displacement device for the workpiece table is a chain drive.

4. The laser processing machine according to claim 3, wherein the chain drive comprises a chain having at least one carrier to which the support device can be secured.

5. The laser processing machine according to claim 3, wherein the support device has a coupling device which engages with the chain to secure the support drive to the chain drive.

6. The laser processing machine of claim 1, further comprising a guide device for guiding the support device during displacement within the processing range.

7. The laser processing machine of claim 1, wherein the support device forms a support for the pipe-like workpiece.

8. The laser processing machine of claim 7, wherein the support device comprises a feed-through chuck for the pipe-like workpiece.

9. The laser processing machine of claim 1, wherein the handling device further comprises a rotatable clamping chuck acting as an axis of rotation for the pipe-like workpiece.

10. The laser processing machine according to claim 1, further comprising a control device for coupling the movement of the laser processing head and the support device in the longitudinal direction of the pipe-like workpiece.

11. The laser processing machine according to claim 1, wherein the support device is secured to a displacement device of the laser processing head.

12. The laser processing machine according to claim 1, wherein the support device is configured to move in a controlled manner in the longitudinal direction of the pipe-like workpiece over at least 50% of the processing range.

13. The laser processing machine according to claim 1, wherein the processing range is defined by the maximum travel distance of a laser processing head along a longitudinal axis of the pipe-like workpiece.

14. A method for retrofitting a laser processing machine from processing plate-like workpieces to processing pipe-like workpieces, the method comprising:
securing a support device for supporting a pipe-like workpiece to a displacement device of the laser processing machine for the controlled movement of the support device in a longitudinal direction of the pipe-like workpiece over at least 20% of a processing range.

15. The method according to claim 14, wherein the support device is secured to a displacement device for a workpiece table.

16. The method according to claim 14, wherein the support device is secured to a displacement device for the laser processing head.

17. The method according to claim 14, wherein the support device comprises a feed-through chuck for the pipe-like workpiece.

18. The method according to claim 14, wherein the support device further comprises a rotatable clamping chuck acting as an axis of rotation for the pipe-like workpiece

19. The method according to claim 14, wherein the displacement device for the workpiece table is a chain drive.

20. The method according to claim 19, wherein the support device has a coupling device which engages with the chain to secure the support drive to the chain drive.

21. The method according to claim 14, wherein the support device is configured to move in a controlled manner in the longitudinal direction of the pipe-like workpiece over at least 50% of the processing range.

22. The method according to claim 14, wherein the processing range is defined by the maximum travel distance of a laser processing head along a longitudinal axis of the pipe-like workpiece.
